(19) United States
(12) Patent Application Publication
(10) Pub. No.: US 2005/0276473 A1
(43) Pub. Date: Dec. 15, 2005

(54) Apparatus and method of detecting color gamut in color device and calculating color space inverse transform function

(76) Inventors: Jin-sub Um, Suwon-si (KR); Moon-cheol Kim, Suwon-si (KR)

Correspondence Address: STANZIONE & KIM, LLP, 919 18TH STREET, N.W., SUITE 440, WASHINGTON, DC, 20006, US

(21) Appl. No.: 11/141,241

(22) Filed: Jun. 1, 2005

(30) Foreign Application Priority Data
Jun. 11, 2004 (KR) 2004-43119

(51) Int. Cl. H04N 1/40

(52) U.S. Cl. 382/167

(57) ABSTRACT

An apparatus and a method of detecting a color gamut of a color device and a method of calculating a color space inverse transform function using the same. The color gamut detecting apparatus includes a color space converter to convert a color space of an input color signal to a device-independent color space and to output a first color signal, an intersection point detector to detect an intersection point between a boundary surface of a color gamut of the first color signal and a plane of a uniform hue, and a control vector calculator to calculate a control vector corresponding to a primary color value of the detected intersection point. Therefore, a precise color gamut can be detected by calculating a control vector in a device-dependent color space based on an intersection point with the plane of the uniform hue or the plane of the uniform lightness in the device-independent color space.

### CROSS-REFERENCE TO RELATED APPLICATIONS

This application claims the benefit of Korean Patent Application No. 2004-43119 filed Jun. 11, 2004, in the Korean Intellectual Property Office, the disclosure of which is incorporated herein by reference.

### BACKGROUND OF THE INVENTION

1. Field of the Invention

The present general inventive concept relates to an apparatus and a method of detecting a color gamut boundary in a color device and a method of calculating a color space inverse transform function using the same. More particularly, the present general inventive concept relates to a color gamut detecting apparatus and method that can acquire a color gamut of a color device according to an intersection point formed with a plane of a uniform hue and a plane of a lightness in a device-independent color space, and a method of calculating the color space inverse transform function using the method.

2. Description of the Related Art

Generally, color reproducing devices, for example, a monitor, a scanner and a printer, use a different color space or a color model according to their own application fields. For example, a color image printing device uses a CMY (Cyan, Magenta and Yellow) color space, while a color Cathode-Ray Tube (CRT) monitor and a computer graphic device use an RGB (Red, Green and Blue) color space. Devices for controlling hue, saturation and intensity use an HSI (Hue, Saturation and Intensity) color space. In addition, Commission Internationale de l'Eclairage (CIE) color spaces are used to define device-independent colors, that is, to reproduce colors precisely in any kind of devices. Among the CIE color spaces are CIE-XYZ, CIE L*a*b, and CIE l*u*v color spaces.

Besides the difference in the color spaces, the color reproducing devices can have a different color gamut. While a color space signifies a method for defining colors, that is, a method for describing a relationship between colors, the color gamut means a color reproduction range. Therefore, if the color gamut of an input color signal is different from that of a device that reproduces the input color signal, color gamut mapping should be performed to improve color reproducibility by transforming the input color signal properly to match the color gamuts of the input color signal and the device.

The color reproducing devices generally uses three primary colors. However, there is a recent attempt to extend the color gamut using more than four primary colors. The attempt is represented by MultiPrimary Display (MPD), which is a display system that extends the color reproducibility using more than the four primary colors to extend the color gamut wider than the conventional three-channel display system using the three primary colors.

The color gamut mapping between two different color devices is generally carried out with respect to lightness and chroma without changing hue, after transforming the color space of the input color signal. To be specific, the color space of the input color signal is transformed from a device-dependent color space (DDCS), such as the RGB or CMYK color space, to a device-independent color space (DICS) such as the CIE-XYZ color space or the CIE-LAB color space. Then, the device-independent color space is transformed into an LCH coordinates system (color space) which represents lightness, chroma and hue, and the color gamut mapping is performed with respect to the lightness and chroma on a plane of a uniform hue. Here, the color gamut of a device in the device-independent color space and the LCH color space should be known before the color gamut mapping is performed.

Among the methods for figuring out the color gamut of a device is an iterative method, in which it is checked whether a control vector in the device-dependent color space is overflown by increasing or decreasing a chroma value in uniform hue and lightness. However, the iterative method requires a long time to figure out the color gamut of the device and, if the device has more than four channels, it is hard to perform inverse transform between the device-dependent color space and the device-independent color space. Therefore, it is difficult to obtain the color gamut of the device.

Another method is a surface sampling method, in which the color gamut of a device is figured out by sampling a surface of the device-dependent color space and transforming the values obtained from the sampling into the values of the device-independent color space. The surface sampling method has advantages in that it takes a less time than the iterative method and does not require the inverse transform. However, since the uniform sampling in the device-dependent color space can be non-uniform in the device-independent color space according to color spaces, there is a problem that vacancy or color crumple may occur in an output image.

Also, both the iterative method and the surface sampling method have a problem in that cusps of the color gamut can be hardly obtained according to the frequency number of samplings.

### SUMMARY OF THE INVENTION

The present general inventive concept provides a color gamut detecting apparatus and method that can detect a color gamut of a color device precisely by acquiring an intersection points with a plane of a uniform hue or a plane of a uniform lightness in a device-independent color space and calculate a color space inverse transform function based on the intersection point, and provide a method of calculating the color space inverse transform function.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing an apparatus to detect a color gamut in a color device, the apparatus including a color space converter to convent a color space of an input color signal to a device-independent color space and to output a first color signal, an intersection point detector to detect an intersection point between a boundary surface of a color gamut of the first color signal and a plane of a uniform hue, and a control vector calculator to calculate a control vector corresponding to a primary color value of the detected intersection point.

The intersection point detector may further an intersection point between the boundary surface of the color gamut of the first color signal and a plane of a uniform lightness.

The foregoing and/or other aspects and advantages of the present general inventive concept may also be achieved by providing a method of detecting a color gamut of a color device, the method including converting a color space of an input color signal to a device-independent color space and outputting a first color signal, detecting an intersection point between a boundary surface of a color gamut of the first color signal and a plane of a uniform hue, calculating a control vector corresponding to a primary color value of the detected intersection point.

The device-independent color space is a WYV color space, and the intersection point exists between a WV plane of the WYV color space and a plane of a uniform hue which is parallel to the WV plane.

The intersection point may be calculated according to an equation which is expressed as:

$$v = tan ( θ ) \cdot w and \frac{w - {w}_{a}}{{w}_{b} - {w}_{a}} = \frac{y - {y}_{a}}{{y}_{b} - {y}_{a}} = \frac{v - {v}_{a}}{{v}_{b} - {v}_{a}}$$

where θ is the size of hue, (wₐ, yₐ, vₐ) and (w_{b}, y_{b}, v_{b}) are cusps of the color gamut of the first color signal, and the intersection point exists in a straight line connecting the cusps.

The intersection point may exist between the boundary surface of the color gamut of the first color signal and a plane having a uniform lightness.

When a straight line is drawn between two cusps among the cusps of the color gamut of the first color signal, the control vector of the intersection point is calculated based on a ratio of a distance between the two cusps disposed on the straight line where the intersection point exists, and a distance between any one of the two cusps and the intersection point.

The control vector of the intersection point may be calculated based on equations:

$$q = \sqrt{{( {w}_{a} - {w}_{b} )}^{2} + {( {y}_{a} - {y}_{b} )}^{2} + {( {v}_{a} - {v}_{b} )}^{2}} , \\ r = \sqrt{{( {w}_{c} - {w}_{a} )}^{2} + {( {y}_{c} - {y}_{b} )}^{2} + {( {v}_{c} - {v}_{a} )}^{2}} , \\ {R}_{c} = \frac{r}{q} \cdot ( {R}_{b} - {R}_{a} ) + {R}_{a}$$

where (wₐ, yₐ, vₐ) and (w_{b}, y_{b}, v_{b}) are two cusps of the color gamut of the first color signal; (w_{c}, y_{c}, v_{c}) denotes the intersection point; q denotes a distance between the two cusps; r denotes a distance between the intersection point and an cusp having a smaller value between the two cusps; and R denotes a primary value of the intersection point.

The foregoing and/or other aspects and advantages of the present general inventive concept may also be achieved by providing a method of calculating a color space inverse transform function by using a color gamut detecting method of a color device, the method including outputting a first color signal by converting a color space of an input color signal to a device-independent color space, detecting an intersection point between a boundary surface of a color gamut of the first color signal and a plane of a uniform hue, calculating a control vector corresponding to a primary value of the detected intersection point, and calculating a control vector of a random point existing in a space defined by connecting the intersection point on the plane of the uniform hue.

The control vector at the random point can be calculated based on equations:
V_{Q}=α(VC(i)−VZ)+β(VC(i+1)−VZ)+VZ,
Q_{L}−Z_{L}=α(C_{L}(i)−Z_{L})+β(C_{L}(i+1)−Z_{L}), and
Q_{c}−Z_{c}=α(C_{c}(i)−Z_{c})+β(C_{c}(i+1)−Z_{c}),
wherein Z denotes a random point on a gray axis; V_{Q} is a vector of the random point; VZ denotes a vector of the point Z; VC(i) is a control vector of an i^{th} intersection point; C_{L}(i) and C_{c}(i) denote lightness and chroma at the i^{th} intersection point, individually; α and β are random constants; and Z_{L} and Z_{c} denote lightness and chroma at the point Z, individually.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A and 1B are diagrams illustrating intersection points of a color device having a plurality of channels;

FIG. 2 is a block diagram illustrating a color gamut detecting apparatus of a color device according to an embodiment of the present general inventive concept;

FIGS. 3 and 4 are diagrams illustrating an operation of a color space converter of FIG. 2;

FIG. 5 is a diagram illustrating operations of an intersection point detector and a control vector calculator of FIG. 2 to detect a control vector of an intersection point;

FIG. 6 is a flowchart illustrating a color gamut detecting method of a color device according to an embodiment of the present general inventive concept; and

FIGS. 7A and 7B are diagrams illustrating a method of obtaining a color space inverse transform function using a color gamut detecting method according to an embodiment of the present general inventive concept.

### DETAILED DESCRIPTION OF THE PREFERRED EMBODIMENTS

Certain embodiments of the present general inventive concept will be described in greater detail with reference to the accompany drawings.

In the following description, same drawing reference numerals are used for the same elements even in different drawings. The matters defined in the description such as a detailed construction and elements are nothing but the ones provided to assist in a comprehensive understanding of the general inventive concept. Thus, it is apparent that the present general inventive concept can be carried out without those defined matters. Also, well-known functions or constructions are not described in detail since they would obscure the invention in unnecessary detail.

Hereinafter, the present general inventive concept will be described by taking an example where a color gamut of a 5-channel color device is detected.

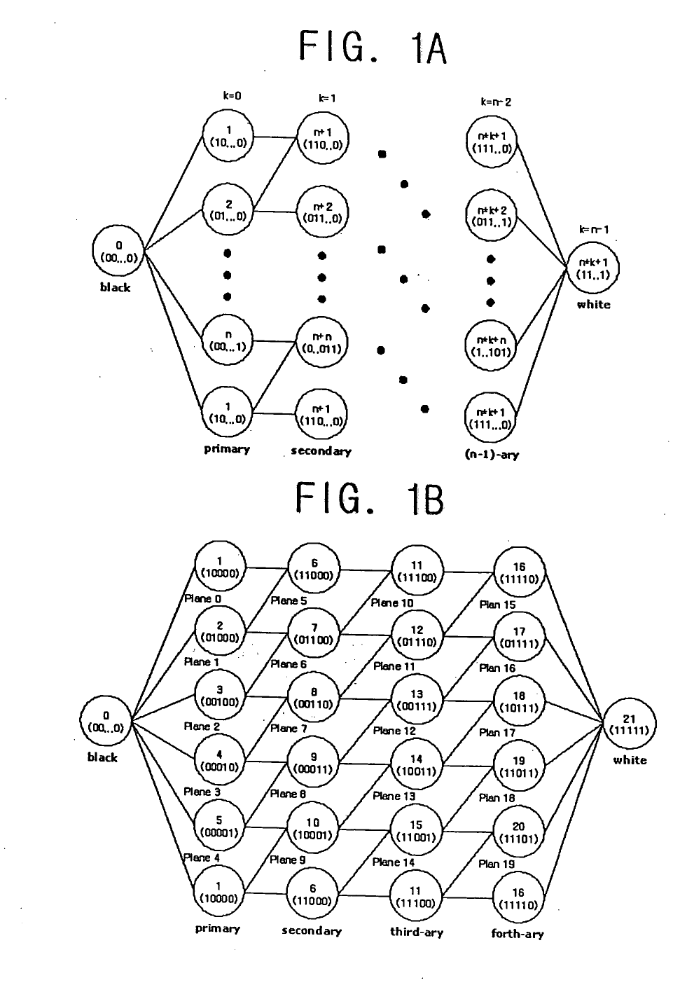

FIGS. 1A and 1B are diagrams illustrating intersection points of a color device having a plurality of channels.

FIG. 1A shows the intersection points of an n-channel color device arranged geometrically in an n-dimensional space. A color device having n primary colors has n*(n−1) planes and has n*(n−1)+2 control points. Here, a polyhedron having a plurality of planes corresponds to a color gamut.

FIG. 1B presents a 5-channel color device of RYGCB which is obtained by adding yellow (Y) and cyan (C) to RGB (Red, Green, and Blue).

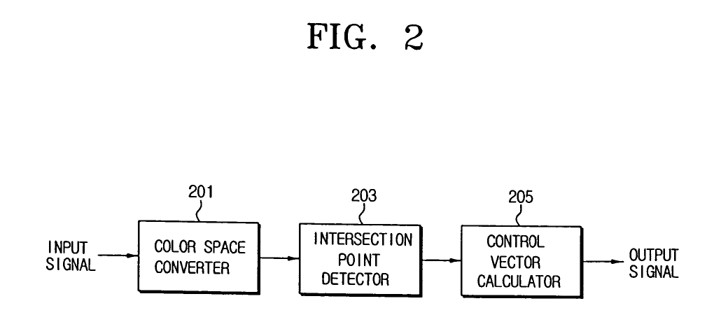

FIG. 2 is a block diagram illustrating a color gamut detecting apparatus of a color device according to an embodiment of the present general inventive concept.

As shown in FIG. 2, the color gamut detecting apparatus of the color device comprises a color space converter 201, an intersection point detector 203, and a control vector calculator 205.

First, the color space converter 201 converts a color space of an input color signal into a WYV color space, which is a device-independent color space. The conversion of the color space is carried out to detect a color gamut by obtaining cusps of the color gamut. The cusps of the color gamut is obtained by calculating intersection points between a WV plane of the WYV color space and a plane of a uniform hue or a plane of a uniform lightness (brightness).

The intersection point detector 203 detects an intersection point between a color gamut boundary surface and a plane that is perpendicular to the WV plane which is positioned at an angle θ from a W axis with respect to the input color signal whose color space is converted to the WYV color space, and also detects an intersection point between the color gamut boundary surface and the plane of the uniform lightness that is parallel to the WV plane which is positioned at an angle θ from the W axis. Here, the intersection points are detected using the cusps of a plurality of planes existing in the WYV color space, that is, the cusps of the color gamut in the WYV color space. Since the intersection points between the plane perpendicular to the WV plane and the color gamut boundary surface are the cusps of the color gamut in an LCH (luminosity, chroma, and hue) color space, a color gamut of the LCH color space can be detected by connecting the intersection points. Also, since the intersection points between the plane of the uniform lightness which is parallel to the WV plane and the color gamut boundary surface are cusps of the color gamut in the WYV color space, the color gamut of the WYV color space can be detected by connecting the intersection points.

The control vector calculator 205 calculates control vectors of the obtained intersection points. Here, the control vector represents primary color values such as R, G, B, Y and C. In short, the control vector calculator 205 calculates the primary color values of the intersection points. The control vector of the intersection points can be obtained based on a function with respect to the cusps of the WYV color space and a distance to the intersection points. The control vector at an intersection point can also be used to obtain a control vector at a random point in the plane of the uniform hue or the plane of the uniform lightness. Thus, it is possible to obtain an inverse transform function to transform the color space of a signal from the device-independent color space into the device-dependent color space.

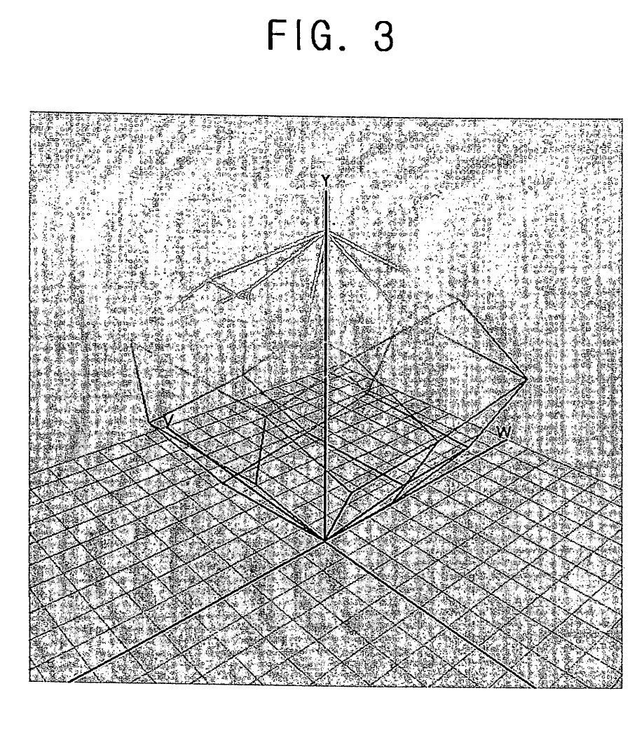

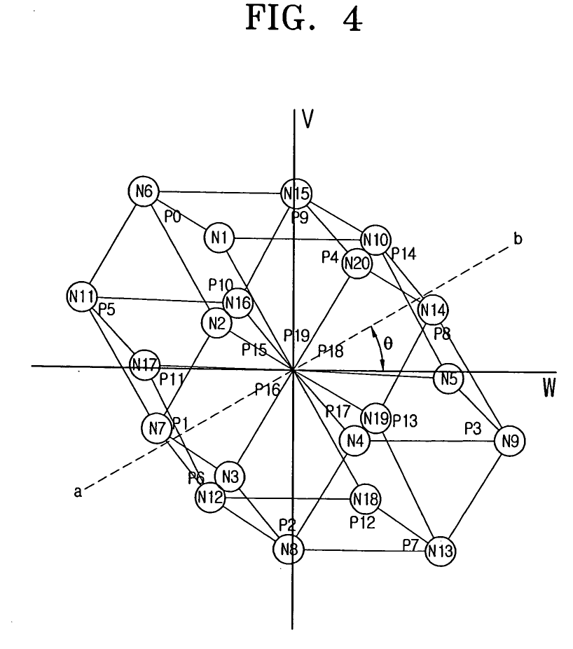

FIGS. 3 and 4 are diagrams illustrating an operation of the color space converter 201 of FIG. 2. FIG. 3 presents the color gamut in the WYV color space which is formed through linear conversion of an XYZ color space (or coordinates). It shows the plane of the control vectors of the intersection point diagram of FIG. 1B in the WYV color space. FIG. 4 shows the color gamut projected onto the WV plane. N1 through N20 represent the intersection points, and Po through P19 represent plains.

As shown in FIGS. 3 and 4, the color space converter 201 converts the color space of the inputted color signal into the device-independent WYV color space. This color gamut mapping can be achieved because it is performed in a lightness-chroma plane, which is a plane having a uniform hue in the device-independent color space.

The WYV color space uses a Y axis of the XYZ color space as an axis of lightness (brightness or luminance) and presents WV to indicate B-Y chromaticity and R-G chromaticity. The WYV color space is color coordinates where the primary colors R, G, and B of the RGB system are 120, 240 and 0. The R, G, B, C, M and Y hues appear at a regular interval. The XYZ color space is converted into the WYV color space in an sRGB system based on [Equation 1] as follows:

$$\vert \begin{matrix}W \\ Y \\ V\end{matrix} \vert = \vert \begin{matrix}- 0.5401 & - 0.1866 & 0.6428 \\ 0 & 1 & 0 \\ 1.8231 & - 1.4780 & - 0.2339\end{matrix} \vert \vert \begin{matrix}X \\ Y \\ Z\end{matrix} \vert \qquad [ Equation 1 ]$$

where coefficients of the [Equation 1] depend on each color device.

Since the color gamut mapping is generally carried out on a lightness-chroma plane with the uniform hue, the color space converter 201 may convert the WYV color space into the LCH color space. The conversion from the WYV color space into the LCH color space may be performed based on [Equation 2] as follows:

$$L = Y \\ C = \sqrt{{W}^{2} + {V}^{2}} \\ H = {tan}^{- 1} ( \frac{V}{W} ) \qquad [ Equation 2 ]$$

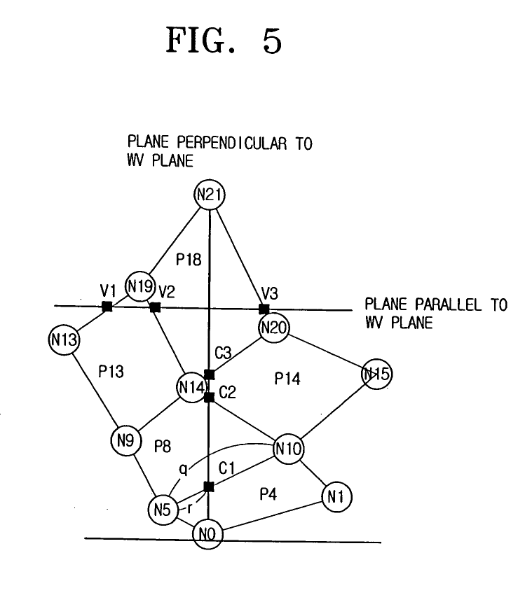

FIG. 5 is a diagram illustrating operations of the intersection point detector 203 and the control vector calculator 205 of FIG. 2. The control vector calculator 205 detects the control vector of each intersection point.

FIG. 5 shows intersection points and intersection lines between a plane perpendicular to the WV plane positioned at an angle θ from the W axis and a color gamut boundary surface, and the intersection points and intersection line between an L plane (lightness plane) parallel to the WV plane positioned at an angle θ from the W axis and the color gamut boundary surface. That is, it shows the WV plane from a viewpoint of an a-b axis of FIG. 4.

As illustrated in FIG. 5, V1, V2 and V3 are intersection points between the plane parallel to the WV plane and the color gamut boundary surface. The intersection points V1, V2, and V3 have the same lightness. On the other hand, C1, C2 and C3 are intersection points between the plane perpendicular to the WV plane and the color gamut boundary surface, and the intersection points C1, C2 and C3 have the same hue (hue=θ).

First, the operation of the intersection point detector 203 will be described with respect to FIGS. 2 through 5.

In order to detect the color gamut for a hue, the cusps of the color gamut in the LCH color space are acquired by calculating the intersection points between the plane perpendicular to the WV plane positioned at the angle θ from the W axis and a three-dimensional color gamut boundary surface. Here, the intersection points exist between a plane whose hue is the angle θ, and the color gamut plane. The intersection points correspond to the C1, C2 and C3 of FIG. 5 have the same hue. The intersection points are calculated by examining the planes illustrated in FIGS. 1A and 1B sequentially. In other words, the intersection points are calculated by examining the color gamut, i.e., planes in the WYV color space, which is illustrated in FIG. 4.

The control vector calculator 205 acquires the control vectors of the intersection points by calculating primary color values of the intersection points detected in the intersection point detector 203, that is, values of the R, G, B, C and Y The control vector, which is a color value at a random point of a color gamut, can be obtained by using the primary color values of the intersection points obtained in the control vector calculator 205. Therefore, it is possible to obtain an inverse transform function for inverse-transforming the device-independent color space of a signal into the device-dependent color space by calculating the color value at the random point of the obtained color gamut.

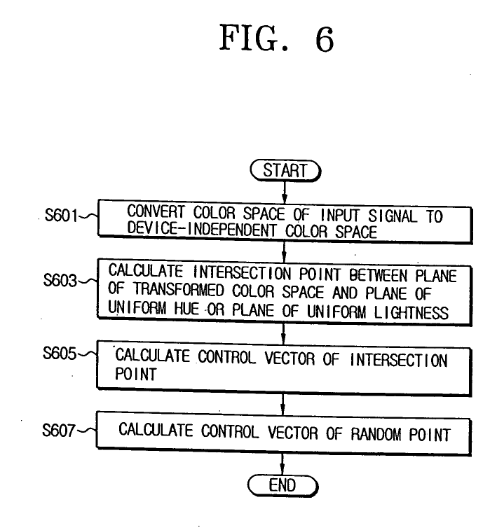

FIG. 6 is a flowchart illustrating a color gamut detecting method of a color device according to an embodiment of the present general inventive concept. First, the color gamut detecting method will be described by taking an example where the color space is a linear transform of the XYZ color space.

Referring to FIGS. 2 through 6, at operation S601, the color space of an input color signal is converted to a device-independent color space. In the embodiment of the present inventive concept, it is assumed that the color space converter 201 converts the color space of the input color signal to the WYV color space.

Subsequently, at operation S603, the intersection points between the plane of the uniform hue, which is perpendicular to the WV plane, and the plane of the uniform lightness, which is parallel to the WV plane, are obtained in the intersection point detector 203. The intersection points become the cusps of the color gamut in the LCH color space and the cusps of the color gamut in the WYV color space. An area defined by connecting the intersection points and black and white points becomes the color gamut. The intersection points between the color gamut in the WYV color space and the plane of the uniform hue which is perpendicular to the WV plane become the cusps of the color gamut in the LCH color space. The intersection points between the color gamut in the WYV color space and the plane of the uniform lightness which is parallel to the WV plane become the cusps of the color gamut in the WYV color space.

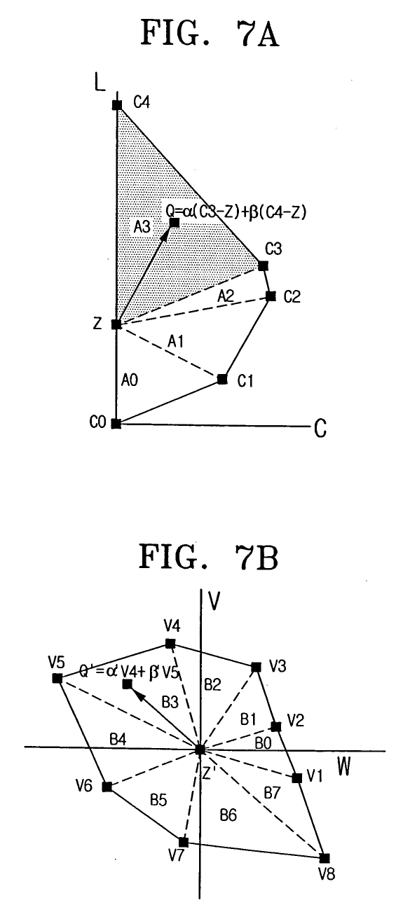

In FIG. 5, the intersection points C1, C2 and C3 between a plane of the WYV color space and the plane of the uniform hue which is perpendicular to the WV plane are cusps of the color gamut in the LCH color space. When the intersection points are connected, the color gamut of the LCH color space is obtained as shown in FIG. 7A. Also, in FIG. 5, the intersection points V1, V2 and V3 between the plane of the WYV color space and the plane of the uniform lightness which is parallel to the WV plane are cusps of the color gamut in the WYV color space. When the intersection points are connected, the color gamut of the WXY color space is obtained as shown in FIG. 7B.

Hereafter, a method of detecting intersection points in the intersection point detector 203 will be described with reference to FIGS. 2 through 5.

The method will be described by taking as an example a case of FIG. 4 where the cusps of the LCH color space are obtained by calculating the intersection points between a plane perpendicular to the WV plane positioned at an angle of θ with respect to the W axis and three-dimensional color gamut boundary surfaces. In FIG. 4, the intersection points exist between the plane with the hue of the angle θ (hue=θ) and the color gamut plane. Thus, the intersection points C1, C2 and C3 have the same hue. The intersection points are obtained by examining the planes of FIGS. 1A and 1B sequentially and calculating the intersection points with the plane perpendicular to the WV plane in the WYV color space.

The operation of detecting the intersection points will be described by taking a case of FIG. 5 where the intersection point C1 (w_{c1}, y_{cl}, v_{cl}) is calculated as an example. In FIG. 5, q denotes a distance between an intersection point N5 and an intersection point N10, and r denotes a distance between the intersection point N5 and the intersection point C1. A hue plane can be obtained based on [Equation 3] as follows:
v=tan(θ)·w=k·w [Equation 3]

A straight line connecting the intersection point N5 (w₅,y₅,v₅) and the intersection point N10 (w₁₀, y₁₀, v₁₀) in a plane P8 is expressed by [Equation 4] as follows:

$$\frac{w - {w}_{5}}{{w}_{10} - {w}_{5}} = \frac{y - {y}_{5}}{{y}_{10} - {y}_{5}} = \frac{v - {v}_{5}}{{v}_{10} - {v}_{5}} \qquad [ Equation 4 ]$$

where w, y and v are random points in the straight line between the intersection point N5 (w₅, y₅, v₅) and the intersection point N10 (w₁₀, y₁₀, v₁₀).

The equation 4 can be expressed by [Equation 5], when it is rewritten with respect to the w and v to obtain w_{c1} and v_{c1} from the equations 3 and 4.

$$v = \frac{{v}_{10} - {v}_{5}}{{w}_{10} - {w}_{5}} E ( w - {w}_{5} ) + {v}_{5} = a \cdot w + b \qquad [ Equation 5 ]$$

When the equations 3 and 5 are calculated with respect to w_{c1} and v_{c1}, the w_{c1} and v_{c1} can be obtained by [Equation 6] as follows:

$${w}_{c1} = \frac{b}{k - a} \\ {v}_{c1} = \frac{kb}{k - a} \qquad [ Equation 6 ]$$

Also, y_{c1} can be obtained from the equations 4 and 6 and the y_{c1} is expressed by [Equation 7] as follows:

$${y}_{c 1} = \frac{{y}_{10} - {y}_{5}}{{w}_{10} - {w}_{5}} E ( {w}_{c 1} - {w}_{5} ) + {y}_{5} or \\ {y}_{c 1} = \frac{{y}_{10} - {y}_{5}}{{v}_{10} - {v}_{5}} E ( {v}_{c 1} - {v}_{5} ) + {y}_{5} \qquad [ Equation 7 ]$$

Another intersection points C2 (w_{c2}, y_{c2}, v_{c2}) and C3 (w_{c3}, y_{c3}, v_{c3}) can be obtained in the same method as the intersection point C1. Thus, the color gamut can be defined by connecting the obtained intersection points C1, C2, and C3 and the black and white points.

Therefore, a chroma of an arbitrary hue can be calculated based on the lightness in the color gamut boundary. Values of lightness L and chroma C at each cusp can be calculated based on the [Equation 2]. The value of the chroma C at an arbitrary value L on the color gamut boundary can be calculated as [Equation 8] as follows:

$$C = \frac{{C}_{c} ( i + 1 ) - {C}_{c} ( i )}{{C}_{L} ( i + 1 ) - {C}_{L} ( i )} \cdot ( L - {C}_{L} ( i ) ) + {C}_{c} ( i ) , \\ {C}_{L} ( i ) \leq L \leq {C}_{L} ( i + 1 ) \qquad [ Equation 8 ]$$

where C_{c}(i) and C_{L}(i) denote a chroma value and a lightness value at an i^{th} cusp, C and L denote chroma and lightness, respectively, and the lightness value C₂(i) is larger than the lightness value at the i^{th} cusp and smaller than the lightness value at an (i+1)^{th} cusp.

Other intersection points can be obtained in the same method as the intersection point C1. Subsequently, at operation S605, control vectors, which are color values of the intersection points detected in the intersection point detector 203, can be obtained in the control vector calculator 205. At operation S607, control vectors for other arbitrary points are calculated in the control vector calculator 203 based on the control vectors of the intersection points. The control vectors for the intersection points can be obtained by using the cusps of the color gamut in the XYV color space and a function for a distance to an intersection point detected in the intersection point detector 203. The control vector for a random point can be obtained in the plane of the uniform hue and it can be obtained using the control vectors of the intersection points in the plane of the uniform lightness in the WYV color space.

First, a method of calculating a control vector of an intersection point, which is detected in the intersection point detector 203, in the control vector calculator 205 will be described.

The control vector of the intersection point C1 can be obtained based on a function for a distance (N5-C1) between the intersection point N5 and the intersection point C1 and a distance (C1-N10) between the intersection point C1 and the intersection point N10. Since WYV is a linear transform of XYZ and XYZ also is linear conversion of five control vectors R, Y, G, C and B of a color device, the control vector of the intersection point C1 can be obtained from the intersection points N5, N10, and C1 based on a function for distances N5-C1 and C1-N10. Here, when the distances N5-N10 and C1-N10 are q and r, the distances q and r can be expressed by [Equation 9] as follows:
q=√\overline{(w₁₀−w₅)²+(y₁₀−y₅)²+(v₁₀−v₅)²}
r=√\overline{(w_{c1}−w_{c5})²+(y_{c1}−y₅)²+(v_{c1}−v₅)²} [Equation 9]

When the control vectors at the intersection points N5, N10, and C1 are V₅(R₅,Y₅,G₅,C₅,B₅), V₁₀(R₁₀,Y₁₀,G₁₀,C₁₀,B₁₀), and V_{c1}(R_{c1},Y_{c1},G_{c1},C_{c1},B_{c1}), R_{c1} can be obtained based on a ratio of q to r. The R_{c1} is expressed by [Equation 10] as follows:

$${R}_{c1} = \frac{r}{q} \cdot ( {R}_{10} - {R}_{5} ) + {R}_{5} \qquad [ Equation 10 ]$$

The other elements Y, G, C and B of the control vectors can be obtained in the same method. Therefore, the control vectors for the other intersection points can be obtained in the above-described method.

FIGS. 7A and 7B are diagrams illustrating a method of obtaining a color space inverse transform function using a color gamut detecting method according to an embodiment of the present general inventive concept.

The color space inverse transform function can be obtained using the color gamut detection method. That is, it can be obtained by calculating a control vector for an arbitrary point in the color gamut of the LCH color space which is obtained using the intersection points calculated for the detection of the color gamut. Also, the color space inverse transform function can be obtained by calculating a control vector with respect to a random point in the color gamut of the WYV color space. FIG. 7A shows a case where the color space inverse transform function is obtained in the LCH color space, and FIG. 7B shows a case where the color space inverse transform function is obtained in the WYV color space.

Hereinafter, a method of obtaining a control vector with respect to a random point in a color gamut of an LCH color space will be described with reference to FIGS. 7A and 7B.

FIGS. 7A and 7B show a plane of a uniform hue and a plane of a uniform lightness in the color gamut of FIG. 5, respectively. As illustrated in FIGS. 7A and 7B, Q and Q′ are random points in the plane of the same hue and the plane of the same lightness. In addition, Z and Z′ are reference points in a gray axis, individually.

First, the method of obtaining the control vector with respect to the random point on a plane of the same hue, i.e., an LC plane, will be described with reference to FIG. 7A, which illustrates the plane of the same hue meeting with a plane in the WYV color space of FIG. 5.

Since the control vectors at the cusps of the color gamut in the LCH color space is known as described with reference to FIG. 5, the control vector for the random point Q on the LC plane, which is illustrated in FIG. 7A, can be obtained. When it is assumed that the random point Q belongs to an area A(i) on the LC plane, it can be expressed in the form of a vector by [Equation 11] as follows:
Q−Z=α(C(i)−Z)+β(C(i+1)−Z), QεA(i) [Equation 11]

Here, A(i) is a plane to which the random point Q belongs. The plane A(i) is a plane formed by two intersection points adjacent to the point Q and Z among the intersection points C1, C2 and C3 illustrated in FIG. 5.

The equation 11 re-written with respect to L and C can be expressed by [Equation 12] as follows:
Q_{L}−Z_{L}=α(C_{L}(i)−Z_{L})+β(C_{L}(i+1)−Z_{L}
Q_{c}−Z_{c}=α(C_{c}(i)−Z_{c})+β(C_{c}(i+1)−Z_{c} [Equation 12]

Values α and β can be obtained by solving the equation 12. Thus, the control vector VQ(R_{q},Y_{q},G_{q},C_{q},B_{q}) at the point Q is expressed by [Equation 13] as follows:
V_{Q}=α(VC(i)−VZ)+β(VC(i+1)−VZ)+VZ [Equation 13]

The control vector of the XYZ color space can be obtained in the above-described method. Even when it is hard to obtain a control vector in the XYZ color space because there is no inverse matrix in the color device having a degree of more than 4, the control vector can be obtained in the above-described method. When the degree is more than 4, there are a plurality of solutions which depend on a location of the reference point Z. For example, if the reference point Z is black, a solution having a maximal lightness will be selected. If the reference point Z is white, a solution having a minimal lightness will be selected. If the lightness L of the reference point Z is 0.5 (Z=0.5), a solution having a medium lightness will be selected.

FIG. 7B is a diagram illustrating intersection points between the plane of the WYV color space and the plane of the same lightness in the WV plane. That is, FIG. 7B illustrates the WV plane connecting the intersection points V1, V2 and V3 shown in FIG. 5.

Differently from the case described in FIG. 7A, in FIG. 7B, the control vector is obtained using the WV plane of the uniform lightness, instead of calculating the control vector on the plane of the same hue. The method of calculating the control vector using the WV plane of the same lightness is the same as the method of calculating the control vector using the plane of the same hue. As described before with reference to FIG. 5, since the control vectors of the cusps are known, a control vector for the random point Q′ on the WV plane can be calculated, which is described with reference to FIG. 7B.

When it is assumed that the random point Q′ belongs to an area B(i) on the WV plane, it can be expressed in the form of a vector, which is expressed by [Equation 14] as follows:
Q′−Z′=α(V(i)−Z′)+β(V(i+1)−Z′), Q′εB(i) [Equation 14]

The [Equation 14] can be written with respect to W and V, which is shown in [Equation 15] as follows:
Q′_{w}−Z′_{w}=α(V_{w}(i)−Z′_{w})+β(V_{w}(i+1)−Z′_{w})
Qᵥ−Z′ᵥ=α(Vᵥ(i)−Z′ᵥ)+β(Vᵥ(i+1)−Z′ᵥ) [Equation 15]

The values α and β can be obtained by solving the equation 15. Thus, the control vector VQ′(R_{q},Y_{q},G_{q},C_{q},B_{q}) at the random point Q′ is expressed by [Equation 16] as follows:
V_{Q′}=α(VV(i)−VZ′)+β(VV(i+1)−VZ′)+VZ′ [Equation 16]

As described above, an inverse transform function for transforming the color space of a signal from the device-dependent color space to the device-independent color space can be obtained by calculating a control vector for a random point existing in the color gamut defined by connecting the intersection points.

Meanwhile, the above description is based on a condition that the color space of the color gamut is a linear transform of the XYZ color space, e.g., the WYV color space. However, if the color space is a non-linear transform of the XYZ color space, such as CIE L*a*b, CIE L*u*b, and DIN99, the color gamut can be detected based on the following method.

When the color space is a non-linear transform of the XYZ color space, the color gamut can be detected in various methods. A first method of detecting the color gamut includes sampling a predetermined color space, obtaining intersection points on a plane meeting with a plane of a uniform hue, and connecting the intersection points. A second method of detecting a color gamut includes transforming a non-linear color space into a linear color space and detecting the color gamut when the color space is a linear transform using the above described method. That is, the color gamut is detected by performing an inverse transform operation on the transformed linear color space and then performing the iterative method. That is the color gamut is detected by examining whether the control vector is overflown.

According to the first method, first, a detailed intersection point diagram is drawn up by performing sampling between the intersection points in the intersection point diagram of FIG. 1B and preparing a plurality of planes. Then, as illustrated in FIG. 5, the intersection points are obtained by finding a plane meeting with a hue plane in the three-dimensional color space, and the color gamut is defined by connecting the intersection points. In short, this method detects the color gamut in the same method as the linear transform, after drawing up a detailed intersection point diagram by performing sampling between intersection points in an intersection point diagram. Here, the accuracy and complexity of the color gamut depend on the extent of sampling.

The second method detects the color gamut by transforming the non-linear color space into the linear color space, performing the inverse transform operation on the linear color space, and examining whether the control vector is overflown.

In the above, a 5-channel color device is taken as an example and the method of detecting a color gamut is described. The color gamut of an n-channel color device can be detected in the same method. Also, the control vector between color gamuts can be stored in a lookup table and applied to hardware.

As described above, the present general inventive concept can define a precise color gamut by obtaining a control vector in a device-dependent color space based on an intersection point with a plane of a uniform hue or a plane of a uniform lightness in a device-independent color space.

Also, the method of the present general inventive concept is easier and more effective than the method of examining whether the control vector is overflown after obtaining a color value of the XYZ coordinates and performing inverse transform in a color device having more than four channels or a method of performing sampling on the surface of the device-dependant color space.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus to detect a color gamut in a color device, comprising:
a color space converter to convert a color space of an input color signal to a device-independent color space and to output a first color signal;
an intersection point detector to detect an intersection point between a boundary surface of a color gamut of the first color signal and a plane of a uniform hue; and
a control vector calculator to calculate a control vector corresponding to a primary color value of the detected intersection point.

2. The apparatus as recited in claim 1, wherein the intersection point detector further detects a second intersection point between the boundary surface of the color gamut of the first color signal and a plane of a uniform lightness.

3. The apparatus as recited in claim 1, wherein the color space converter converts the input color signal into a linear color signal, if the input color signal is a non-linear color signal, and converts the color space of the linear color signal into the device-independent color space to thereby output the first color signal.

4. The apparatus as recited in claim 1, wherein the device-independent color space comprises a WYV color space where Y represents lightness and W and Y represent B-Y chromaticity and R-G chromaticity, respectively.

5. The apparatus as recited in claim 1, wherein the intersection point detector detects the one or more control vectors with respect to a random point of on the plane of the uniform hue or a plane of a uniform lightness.

6. The apparatus as recited in claim 1, wherein the device-independent color space comprises a WYV color space, and the intersection point detector detects the one or more intersection points using intersection lines between a lightness plane parallel to a WV plane positioned at an angle with a W axis and a color gamut boundary surface of the first color signal.

7. The apparatus as recited in claim 1, wherein the control vector calculator obtains an inverse transform function to transform the device-independent color space into a device-dependent color space using the one or more control vectors.

8. A method of detecting a color gamut of a color device, the method comprising:
converting a color space of an input color signal to a device-independent color space and outputting a first color signal;
detecting one or more intersection points between a boundary surface of a color gamut of the first color signal and a plane of a uniform hue; and
calculating one or more control vectors corresponding to primary color values of the detected one or more intersection points.

9. The method as recited in claim 8, wherein the device-independent color space comprises a WYV color space, and the one or more intersection points exist between a WV plane of the WYV color space and the plane of the uniform hue which is parallel to the WV plane.

10. The method as recited in claim 8, wherein the detecting of the one or more intersection points comprises detecting the one or more intersection points according to an equation which is expressed as:
$$v = tan ( θ ) \cdot w and$$
$$\frac{w - {w}_{a}}{{w}_{b} - {w}_{a}} = \frac{y - {y}_{a}}{{y}_{b} - {y}_{a}} = \frac{v - {v}_{a}}{{v}_{b} - {v}_{a}}$$
where θ is a size of hue, (wₐ, yₐ, vₐ) and (w_{b}, y_{b}, v_{b}) are cusps of the color gamut of the first color signal, and the intersection points exist on a straight line connecting the cusps.

11. The method as recited in claim 8, wherein detecting of the one or more intersection points comprises detecting the one or more intersection points existing between the boundary surface of the color gamut of the first color signal and a plane having a uniform lightness.

12. The method as recited in claim 8, wherein, when a straight line is drawn between two cusps of a color gamut of the first color signal so that the one or more intersection points exist on the straight line, the calculating of the control vector of the one or more intersection points comprises calculating the one or more control vectors according to a ratio of a distance between the two cusps and a distance between any one of the two cusps and the one or more intersection points.

13. The method as recited in claim 12, wherein the calculating of the one or more control vectors of the one or more intersection points comprises calculating the one or more control vectors according to equations:
$$q = \sqrt{{( {w}_{a} - {w}_{b} )}^{2} + {( {y}_{a} - {y}_{b} )}^{2} + {( {v}_{a} - {v}_{b} )}^{2}} , \\ r = \sqrt{{( {w}_{c} - {w}_{a} )}^{2} + {( {y}_{c} - {y}_{b} )}^{2} + {( {v}_{c} - {v}_{a} )}^{2}} , and$$
$${R}_{c} = \frac{r}{q} \cdot ( {R}_{b} - {R}_{a} ) + {R}_{a}$$
where (wₐ, yₐ, vₐ) and (w_{b}, y_{b}, v_{b}) are two cusps of the color gamut of the first color signal, (w_{c}, y_{c}, v_{c}) denotes the intersection point; q denotes a distance between the two cusps, r denotes a distance between each intersection point and an cusp having a smaller value between the two cusps, and R denotes a primary value of each intersection point.

14. The method as recited in claim 8, wherein, if the input color signal is a nonlinear color signal, the converting of the color space of the input color signal comprises transforming the input color signal to a linear color signal and then transforming the color space of the input color signal to the device-independent color space to thereby output the first color signal.

15. The method as recited in claim 8, wherein the detecting of the one or more intersection points comprises detecting the intersection points using cusps of a plurality of planes existing in the device-independent color space.

16. The method as recited in claim 8, wherein the one or more intersection points comprise cusps of a color gamut of an LCH color space.

17. The method as recited in claim 8, wherein the device-independent color space comprises a WYV color space, and the detecting of the one or more intersection points comprises detecting the one or more intersection points using intersection lines between a plane perpendicular to a WV plane positioned at an angle with a W axis and a color gamut boundary surface of the first color signal.

18. The method as recited in claim 8, wherein the device-independent color space comprises a WYV color space, and the detecting of the one or more intersection points comprises detecting the one or more intersection points using intersection lines between a lightness plane parallel to a WV plane positioned at an angle with a W axis and a color gamut boundary surface of the first color signal.

19. The method as recited in claim 8, wherein the calculating of the one or more control vectors comprises calculating the one or more control vectors using a function of cusps of the device-independent color space and a distance to the one or more intersection points.

20. The method as recited in claim 8, wherein the calculating of the one or more control vectors comprises calculating the one or more control vectors with respect to a random point of on the plane of the uniform hue or a plane of a uniform lightness.

21. The method as recited in claim 8, further comprising:
obtaining an inverse transform function to transform the device-independent color space into a device-dependent color space using the one or more control vectors.

22. A color gamut detecting method of a color device, the method comprising:
outputting a first color signal by transforming a color space of an input color signal to a device-independent color space;
detecting one or more intersection points between a boundary surface of a color gamut of the first color signal and a plane of a uniform hue;
calculating one or more control vectors corresponding to primary values of the detected intersection points; and
calculating second control vectors of one or more random points existing in a space defined by connecting the intersection points on the plane of the uniform hue.

23. The method as recited in claim 22, wherein the calculating of the control vectors at the one or more random points comprises calculating the control vectors according to the control vectors of the one or more intersection points adjacent to the one or more random points.

24. The method as recited in claim 23, wherein the calculating of the second control vectors at the one or more random points comprises calculating the second control vectors according to following equations:
V_{Q}=α(VC(i)−VZ)+β(VC(i+1)−VZ)+VZ,
Z_{L}−Z_{L}=α(C_{L}(i)−Z_{L})+β(C_{L}(i+1)−Z_{L}), and
Q_{c}−Z_{c}=α(C_{c}(i)−Z_{c})+β(C_{c}(i+1)−Z_{c})
where Z denotes a random point on a gray axis, V_{Q} is a vector of the random point, VZ denotes a vector of the point Z; VC(i) is a control vector of an i^{th} intersection point, C_{L}(i) and C_{c}(i) denote lightness and chroma at the i^{th} intersection point, respectively, α and β are random constants, and Z_{L} and Z_{c} denote lightness and chroma at the point Z, respectively.

25. The method as recited in claim 22, further comprising:
calculating a color space inverse transform function using at least one of the one or more control vectors and the one or more second control vectors.
